(19) United States
(12) Patent Application Publication
(10) Pub. No.: US 2012/0117851 A1
(43) Pub. Date: May 17, 2012

(54) Fishing Jig

(76) Inventor: Robert Henry Young, Yantis, TX (US)

(21) Appl. No.: 12/947,024

(22) Filed: Nov. 16, 2010

(51) Int. Cl. A01K 85/00

(52) U.S. Cl. 43/42.39; 43/42.25

(57) ABSTRACT

The present invention relates to a jig used for fishing comprising: a jig head, a jig body, and a tail. Head weights are located in the jig head and the jig head has a chisel end. The jig body is wrapped around the shank of the hook.

### BACKGROUND OF THE INVENTION

1. Field of the Invention

The present invention relates to a jig that comprises a head, body, tail and hook.

2. Description of Related Art

U.S. Pat. No. 6,904,712 relates to a variable weight diamond jig fishing lure has a jig body with an elongated diamond shape, having a greater length than width, with eyes formed into the opposing longitudinal ends for attachment to a fishing line and a fishhook, respectively. The jig body is formed from two symmetrical plates having their central portions stamped, molded, or otherwise formed outward to form a central chamber or cavity for receiving a weight or ballast. Slots are formed in the plates between the cavity and the eye. A lock plate having an eye defined in one end and a lock tab attached by a tang depending from the opposite end are inserted through the slots and rotated to lock opposing ends of the jig body together.

U.S. Pat. No. 7,694,453 relates to a fishing lure, comprising a weighted head to which a hook, spinner and weed guard are attached, and three cutouts made of a flexible, absorbent material that are wrapped and tied around a load collar or extension from the head. The cutouts will make the lure resemble a bait fish such as is eaten by the fish that the user wants to catch. The cutouts may be decorated with beads, feathers and paint, to increase the resemblance to bait fish. The wiggling motion of the jig as it is pulled through the water and the rotation of the spinner will attract fish. Scent may be absorbed and released by the cutouts to further attract fish. The head is preferably made from lead, and the cutouts are preferably made from a microfiber fabric. A first preferred embodiment is called the “switch back”, and a second preferred embodiment is called the “pop”.

U.S. Patent Publication No. 20020032977 relates to a metal lip jig threader device for rigging a flexible plastic bait, frozen bait, cut fresh bait, and live bait having a metal lip with one hook on a leader line in one fluid step. Additional dressing such as feathers, fur or hair can be added to the lure. An improved method is shown for making a metallic lipped live or artificial fish lure with at least one hook. An improved metal lip jig is shown having a hook secured by a rivet and spurs.

### SUMMARY OF THE INVENTION

In an exemplary embodiment of the present invention, there is disclosed a jig used for fishing having a head, a hook, a body, and a tail. The jig head has four distinct features that are significant to the invention: (1) eye placement (2) chisel end (3) smooth taper and (4) weight. The hook is molded with the head creating a solid bond. The jig body, constructed from chenille, is wrapped around the shank of the hook. The tail is constructed from Chinese neck feathers that are placed along the shank of the hook before wrapping the chenille around the hook to form the body. The feathers extend beyond the hook.

It is an object of the present invention for the eye placement to be centered with respect to the weight giving the appearance of “live” bait.

It is an object of the present invention for the jig head to have a chisel head end that acts to guide the jig through the water and prevents the line from twisting.

It is an object of the present invention for jig to fall in a straight line as it drifts, like food-chain prey, through the water.

It is an object of the present invention for the jig head to be weighted lighter than the nominal heads which are currently on the market.

It is an object of the present invention for the head weights to allow the jig to fall slower to increase the likelihood for a strike.

It is an object of the present invention for the jig body to look like live bait.

It is an object of the present invention for the tail to look like that of live bait as it falls or moves through the water.

It is an object of the present invention for the color to look like that of a live food-chain prey.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 illustrates side view of the fishing device in accordance with the principles of the invention.

### DESCRIPTION OF THE PREFERRED EMBODIMENT

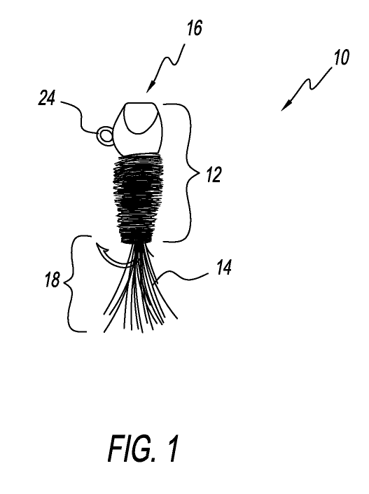

FIG. 1 shows a fishing device 10 having a weighted jig head 12 which is rounded at the base 14 and has a smooth taper chisel end 16 at the top and an eye placement 24. The jig body (not shown) is wrapped around a hook's shank 18 with a feather tail (not shown) which extends past the bend of the hook.

The jig head 12 includes an eye placement 24 which is centered with respect to weight which makes the jig move through the water like live bait.

The chisel End 16 of the jig head acts to guide the jig as it falls and prevents line twist.

The smooth rounded taper shape of the jig body from top to bottom helps the jig fall in a straight line and in a way that it looks like food-chain prey.

Jig head weights of 3/32 and 3/64 ounces which are located in the jig head are lighter than the nominal 1/16 ounce and ⅛ ounce heads on the market. The 3/32 and 3/64 ounce weights allow the jig to fall slower, increasing the likelihood for a strike.

The Jig Body is made with quality chenille which is durable and has the ideal firmness which prevents a fish from dropping it when struck. It is tied in a fashion that compliments the jig head taper to look like live bait.

The tail is constructed from #1 Chinese neck which is selected because it looks like the tail of live bail as it falls or moves through the water. The tail is cut from the neck feather in such a way that it flares when it is stopped and then allowed to fall, just like a minnow or shad. It is attached such that (unlike many other jigs) it will not pull out upon use.

The 32756 hook was selected due to its small diameter, its super sharp point and the temper of the metal. The hook sets with only the flick of the wrist or, in many cases, the hook is set by the fish upon a strike. The temper allows one to pull straight and steady, often saving the jig as opposed to breaking the hook.

Many colors are available but a select few are used because they look like minnows, shad or bugs that fish feed on. Prey was actually caught and then materials which matched their colors were selected. In one embodiment the jig body is colored orange and the tail is colored blue.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A jig used for fishing comprising:
a jig head; a jig body; and a tail;
head weights located in the jig head;
said jig head having a chisel end; and
a hook having the jig body wrapped around the shank of a hook.

2. The device of claim 1 wherein said jig head comprises an eye.

3. The device of claim 2 wherein said eye placement is centered with respect to the weight.

4. The device of claim 1 wherein said jig moves through water as if it were live bait.

5. The device of claim 1 wherein said chisel end guides said jig as it falls and prevents a line connected to said jig from twisting.

6. The device of claim 1 wherein said jig head is a smooth rounded and tapered from top to bottom.

7. The device of claim 1 wherein said jig falls in a straight line and in a way that looks like food-chain prey.

8. The device of claim 1 wherein said head weights are approximately 3/32 and 3/64 weights.

9. The device of claim 1 wherein said body of said jig is made with chenille.

10. The device of claim 1 wherein said jig body is tied in a fashion that compliments said jig head taper to look like live bait.

11. The device of claim 1 wherein said tail is constructed from the #1 Chinese neck.

12. The device of claim 1 wherein said tail looks like that of live bait as it falls or moves through the water.

13. The device of claim 1 wherein said tail is cut from neck feather to flare when it is stopped and then allowed to fall.

14. The device of claim 1 tail looks like that of a minnow or shad.

15. The device of claim 1 wherein said hook is a 32756 hook.

16. The device of claim 1 wherein said hook comprises a small diameter and a sharp point and temper of the metal.

17. The device of claim 1 wherein said jig is a color of a minnow, shad or bug.
